(19) United States
(12) Patent Application Publication
(10) Pub. No.: US 2011/0147453 A1
(43) Pub. Date: Jun. 23, 2011

(54) VENDING MACHINE MEMORY KEY AND/OR CARD READER

(76) Inventors: Fabio Vitali, Pordenone (IT); Rinaldo Buffa, Bannia Di Fiume Veneto (IT)

(21) Appl. No.: 12/992,580

(22) PCT Filed: May 12, 2009
(86) PCT No.: PCT/EP09/55729

§ 371 Date: Mar. 4, 2011

(30) Foreign Application Priority Data
May 13, 2008 (IT) TO2008A 000355

(51) Int. Cl. G06K 7/10; G06Q 90/00; G06K 7/01

(52) U.S. Cl. 235/381; 235/439

(57) ABSTRACT

A reader (3), for reading memory keys and/or cards (4), which can be fixed to a product/service vending machine (1), and has a housing (6), and an electronic read and/or identification board (7) housed inside the housing (6) to read the memory keys and/or cards (4). The electronic board (7) has a circuit board (11) in which is formed a central slot (12) extending along a given axis (B) and for insertion of the memory keys and/or cards (4); a projecting tab (13) fixed to the circuit board (11), at an inner lateral edge (12a) of the slot (12), so as to be substantially perpendicular to the circuit board (11) and parallel to the given axis (B); and a first (15) and second (16) antenna fixed firmly to the tab (13) and designed to transmit/receive radio signals at different frequencies.

### TECHNICAL FIELD

The present invention relates to a vending machine memory key and/or card reader.

More specifically, the present invention relates to a memory key and/or card reader for product vending machines, preferably, though not necessarily, for vending food products, and of the type comprising a closed casing housing an electronic read/identification board for reading/identifying data in a user memory key and/or card; to which application the following description refers purely by way of example.

### BACKGROUND ART

In vending machines for food products, such as soft drinks, snacks, or similar, a need is felt to reduce the size of the reader, especially when this is fitted to the outer wall of the machine.

For this purpose, numerous attempts have been made over the past few years to redesign vending machine readers to achieve hardware configurations capable of reducing the overall size of the electronic read/identification board inside the housing, though a good deal of work still remains to be done.

### DISCLOSURE OF INVENTION

It is an object of the present invention to provide a memory key/card reader that can be fitted to an outer wall of a product vending machine, and is more compact than known readers.

According to the present invention, there is provided a vending machine memory key/card reader as claimed in claim 1 and preferably, though not necessarily, in any one of the Claims depending directly or indirectly on claim 1.

According to the present invention, there is also provided a vending machine as claimed in claim 10.

### BRIEF DESCRIPTION OF THE DRAWINGS

A non-limiting embodiment of the present invention will be described by way of example with reference to the accompanying drawings, in which:

FIG. 1 shows a view in perspective of a product/service vending machine featuring a reader in accordance with the teachings of the present invention;

FIG. 2 shows an exploded view of the FIG. 1 reader;

FIG. 3 shows a side view of the electronic read/identification board of the FIG. 2 reader;

FIG. 4 shows a front view of the electronic read/identification board of the FIG. 2 reader.

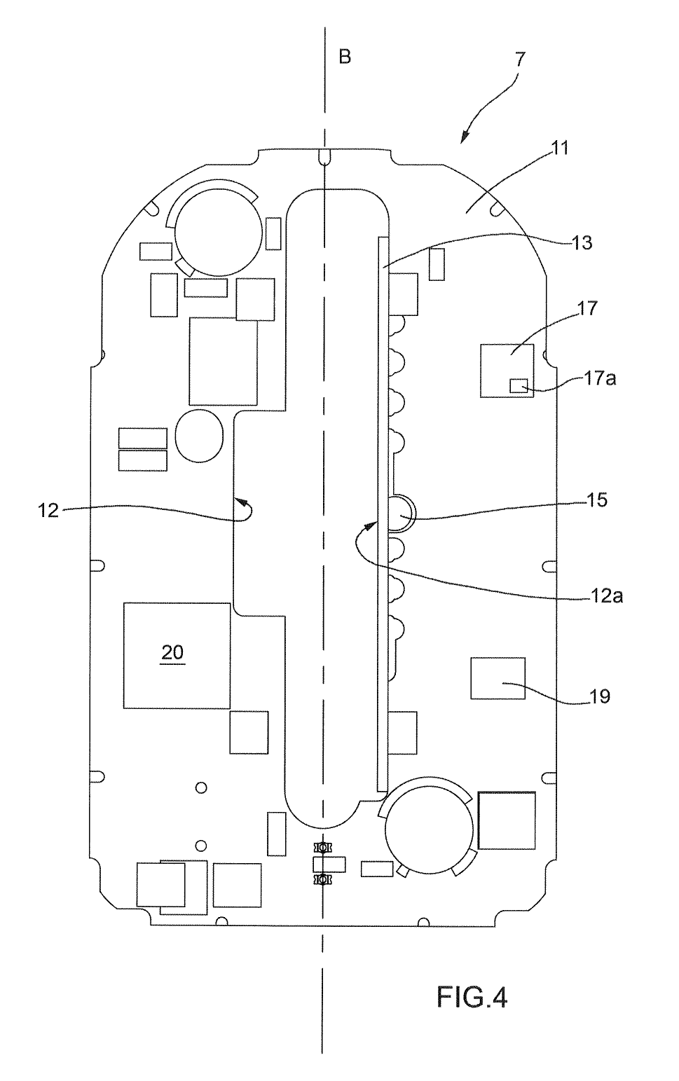

### BEST MODE FOR CARRYING OUT THE INVENTION

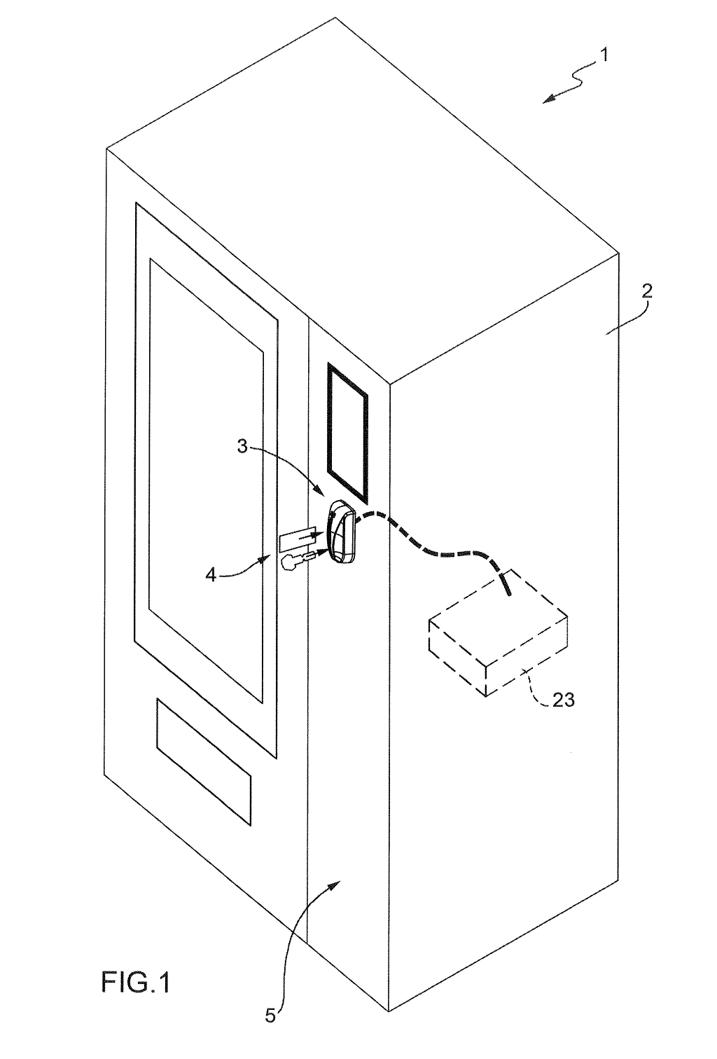

Number 1 in FIG. 1 indicates as a whole a vending machine for dispensing user-requested products and/or services.

Vending machine 1 substantially comprises a preferably, though not necessarily, parallelepiped-shaped casing 2 housing the products/services to be dispensed.

Vending machine 1 also comprises a reader 3, which is fitted preferably to the outside of casing 2 and provides for reading and identifying user data contained in contactless memory keys/cards 4, such as smartcards or similar hardware devices.

The user data stored in memory key/card 4 may comprise, for example, a purchase identification code and/or user credit for purchase of a product/service dispensable by vending machine 1. More specifically, memory key and/or card 4 storing the user data may comprise an RFID TAG (not shown) which communicates by roughly 125 kHz or 13.5 MHz frequency radio signals. In the example shown, the RFID TAG of memory key/card 4 operating at roughly 13.5 MHz communication frequency may be a MIFARE radiofrequency communication type. Memory keys/cards 4 of this sort are known and so not described in detail.

In the FIG. 1 example, reader 3 is fixed firmly, but in easily removable manner, to a front wall 5, i.e. to the exposed wall, of casing 2, and substantially comprises a housing 6; and an electronic read/identification board 7 housed inside housing 6 and for reading/identifying the data/information contained in memory keys and/or cards 4.

More specifically, the exposed face 6a of housing 6 has an elongated opening 8 extending parallel to a predetermined axis A and shaped for insertion of a memory key/card 4.

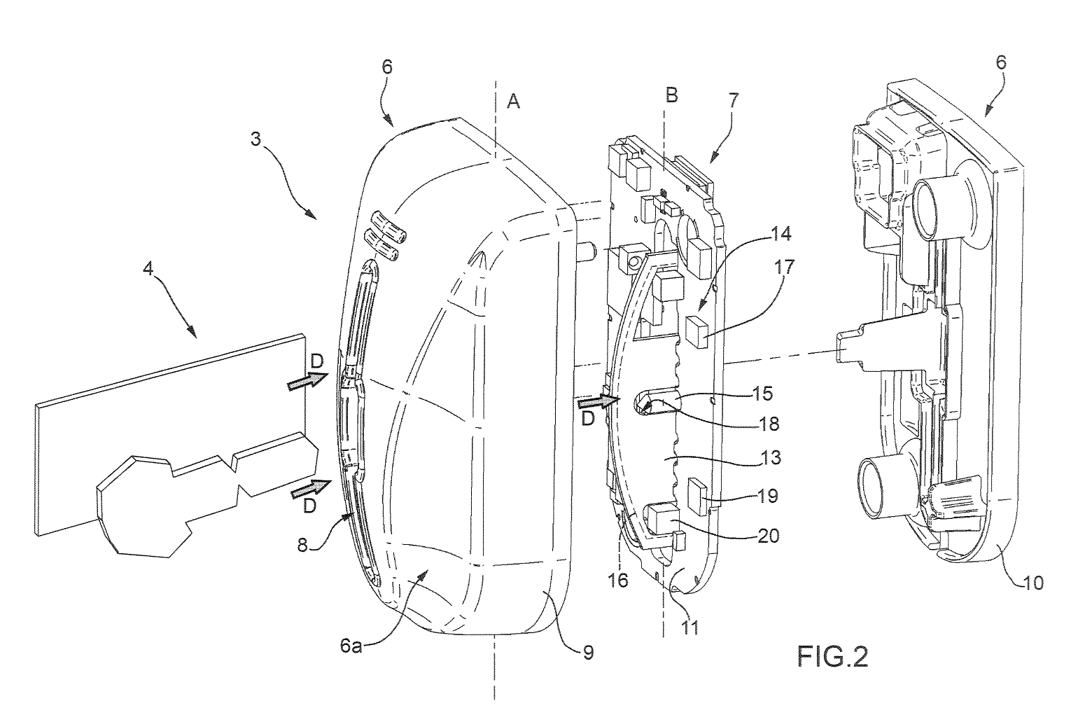

More specifically, in the FIG. 2 example, housing 6 is divided into a front shell 9, in which through opening 8 is formed; and a rear supporting plate 10, which is fixed firmly, but in easily removable manner, to front shell 9 by means of fastening devices (not shown).

Electronic read/identification board 7 comprises a circuit board 11 of insulating electric material, with a central slot 12, which extends along a longitudinal axis B parallel to axis A, and is designed for insertion of a memory key/card 4; and a projecting tab 13 fixed to circuit board 11, at an inner lateral edge 12a of slot 12, so it is substantially perpendicular to circuit board 11.

In the example shown, projecting tab 13 is fixed firmly to circuit board 11, so it is parallel to and faces insertion slot 12 of memory keys and/or cards 4, and is also parallel to the insertion direction D of memory keys and/or cards 4 inside slot 12.

Electronic read/identification board 7 also comprises an electronic transmitting-receiving circuit for transmitting and receiving radiofrequency signals, and in turn comprising at least a first and second antenna 15 and 16, which are both fixed to projecting tab 13, alongside slot 12, and are designed to transmit/receive radiofrequency signals to and from memory keys and/or cards 4.

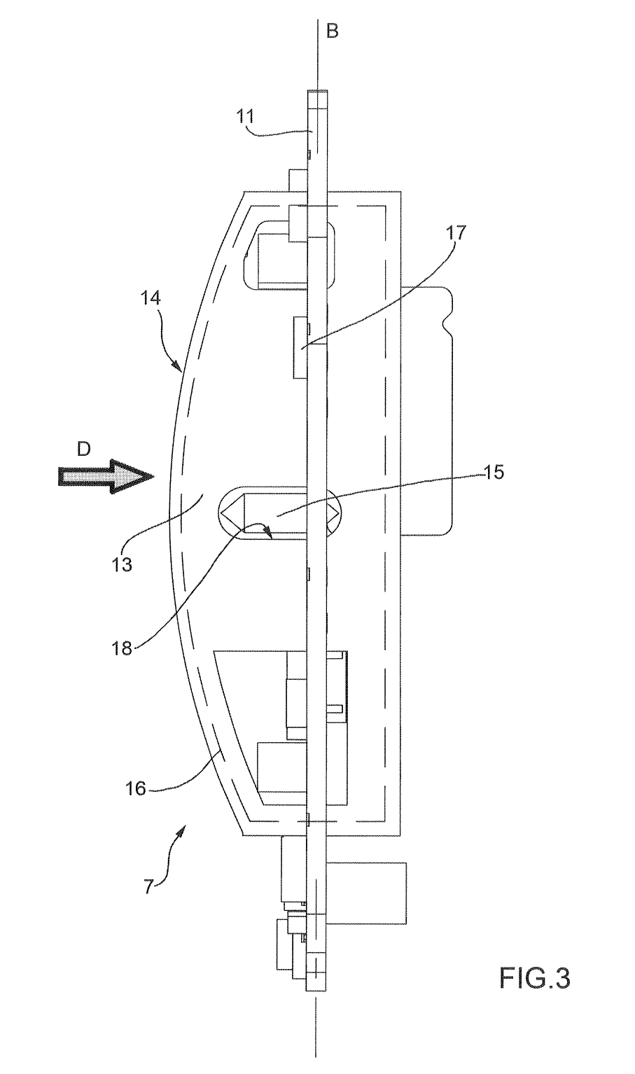

More specifically, first antenna 15 in FIGS. 2 and 3 comprises a dipole, which is housed inside a groove 18 in the centre of projecting tab 13, and transmits/receives roughly 125 kHz frequency signals to and from memory keys and/or cards 4 when these are positioned adjacent to and facing projecting tab 13.

More specifically, the dipole of first antenna 15 has a given impedance, and extends inside groove 18 in a direction substantially perpendicular to circuit board 11 and parallel to the insertion direction D of memory keys and/or cards 4 inside slot 12.

The second antenna 16 in FIGS. 2 and 3 comprises an annular coil of electric conducting material, which extends substantially along the peripheral edge of projecting tab 13, and is designed to transmit/receive radiofrequency signals of roughly 13.5 MHz frequency to and from memory keys and/or cards 4 when these are positioned alongside projecting tab 13.

Transmitting-receiving circuit 14 also comprises a read module 17, which is fixed firmly to circuit board 11 and connected to first and second antenna 15 and 16 to control and decode the radiofrequency signals to and from the memory key and/or card 4 inserted inside slot 12, and to supply the read user data. In the example shown, read module 17 comprises a MIFARE communication technology block 17a.

Electronic read/identification board 7 also comprises an electronic identification module 19 located on circuit board 11, and which identifies the memory key and/or card 4 to accordingly enable, or not, access to the product/service dispensing procedure.

Electronic read/identification board 7 also comprises an electronic pay control module 20 integrated firmly in circuit board 11, and which serves to check and update the credit stored in memory key and/or card 4, and cooperates with a controller 23 (FIG. 1) to control, with the controller, product/service supply to the user.

In actual use, the user inserts memory key/card 4 inside opening 8 in housing 6. At this stage, the end portion of memory key/card 4 is inserted inside slot 12, in a position facing projecting tab 13 and hence first and second antenna 15 and 16. At this point, by means of first antenna 15 or second antenna 16, electronic read module 17 receives the radiofrequency signal containing the user data, so electronic identification module 19 identifies memory key/card 4, and electronic control module 20 commands controller 23 to dispense the requested product/service.

By installing first and second antenna 15 and 16 on the same projecting tab 13, in turn positioned parallel to insertion slot 12 of memory keys/cards 4 and perpendicular to circuit board 11, the reader described above has the advantage of being of extremely small width, thus reducing its overall size and enabling it to be fixed to the outside of vending machine 1.

In addition, the hardware architecture of electronic read/identification board 7, i.e. forming read module 17, identification module 19, and control module 20 on the same electronic board housed inside the reader, has the advantage of greatly simplifying assembly and maintenance of the individual electronic modules.

Clearly, changes may be made to the reader as described and illustrated herein without, however, departing from the scope of the present invention as defined in the accompanying Claims.

1. A reader (3), for reading memory keys and/or cards (4), which can be fixed firmly but in easily removable manner to a product/service vending machine (1), and comprises a housing (6), and an electronic read/identification board (7) housed inside the housing (6) to read/identify data/information contained in said memory keys and/or cards (4); said reader (3) being characterized in that said electronic read/identification board (7) comprises:
a circuit board (11) in which is formed a central slot (12) extending along a given axis (B) and for insertion of said memory keys and/or cards (4);
a projecting tab (13) fixed to said circuit board (11), at an inner lateral edge (12a) of said slot (12), so as to be perpendicular to said circuit board (11) and parallel to said given axis (B); and
a first (15) and second (16) antenna fixed firmly to said projecting tab (13) and designed to operate at different frequencies from each other.

2. A reader as claimed in claim 1, wherein said projecting tab (13) is fixed firmly to said circuit board (11) so as to be parallel to and face said slot (12), and also parallel to an insertion direction (D) of said memory keys and/or cards (4) inside the slot (12).

3. A reader as claimed in claim 1, wherein said first antenna (15) is housed in a groove (18) formed on said projecting tab (13), and is designed to transmit/receive roughly 125 kHz frequency signals to and from said memory keys and/or cards (4).

4. A reader as claimed in claim 1, wherein said second antenna (16) extends along a peripheral edge of said projecting tab (13), and is designed to transmit/receive radiofrequency signals of roughly 13.5 MHz frequency to and from said memory keys and/or cards (4).

5. A reader as claimed in claim 4, wherein said second antenna (16) comprises an annular coil of electric conducting material.

6. A reader as claimed in claim 1, and comprising electronic reading means (17) fixed firmly to said circuit board (11) and connected electrically to said first (15) and second (16) antenna to control and decode the radiofrequency signals transmitted/received to and from said memory keys and/or cards (4).

7. A reader as claimed in claim 6, wherein said electronic reading means (17) comprise a MIFARE technology electronic block (17a).

8. A reader as claimed in claim 1, and comprising electronic identification means (19) fixed firmly to said circuit board (11) and for identifying said memory key and/or card (4) to accordingly enable or disable access to the product/service dispensing procedure.

9. A reader as claimed in claim 1, and comprising electronic pay control means (20) fixed firmly to said circuit board (11), and which check and update credit stored in said memory key and/or card (4), and cooperate with a controller (23) to control dispensing of products/services to the user.

10. A product/service vending machine (1), characterized by comprising a reader (3) as claimed in claim 1.
